(19) United States
(12) Patent Application Publication
(10) Pub. No.: US 2021/0150293 A1
(43) Pub. Date: May 20, 2021

(54) Radio frequency identification tag

(71) Applicant: Commissariat à l'Energie Atomique et aux Energies Alternatives, Paris (FR)

(72) Inventors: Loïc MARNAT, Grenoble (FR); Gilles SIMON, Grenoble (FR)

(21) Appl. No.: 16/949,801

(22) Filed: Nov. 13, 2020

(30) Foreign Application Priority Data
Nov. 19, 2019 (FR) 1912885

(51) Int. Cl. G06K 19/02; G06K 19/077

(52) U.S. Cl. CPC G06K 19/025; H01Q 1/2225; G06K 19/07773

(57) ABSTRACT

The present invention concerns an electronic device (318) including: at least one radio frequency identification tag (302), coated with a resin block (304); a cover (316) forming, with the resin block, at least one notch (320a, 320b); and at least one contacting element (314a, 314b), located at the surface of the resin block inside of the notch.

### FIELD

The present disclosure generally relates to electronic devices and, more particularly, to radio frequency identification tags, or RFID tags.

### BACKGROUND

A radio frequency identification tag, or RFID tag, is frequently attached to an object to, for example, ensure its traceability, to protect it against theft attempts, etc. Such an RFID tag usually comprises an antenna, coupled to an electronic chip. The antenna of the RFID tag for example enables a reader to electrically power the chip to read data which are stored therein. The data stored by the chip are typically information relative to the object having the RFID tag attached thereto.

RFID tags and the chips that they comprise have currently reached a significant miniaturization level. In the textile industry, for example, it is now possible to integrate an RFID tag directly inside of the meshes or of the yarns of a garment. This particularly enables to dissimulate the RFID tag to avoid for it to be removed from the garment by an ill-intentioned person.

The miniaturization of RFID tags however appears to be an issue in terms of mechanical resistance, as well as for the implementation of current methods of manufacturing such tags.

### SUMMARY

There is a need to improve the mechanical resistance of current RFID tags and current RFID tag manufacturing methods.

An embodiment overcomes all or part of the disadvantages of known RFID tags and of known RFID tag manufacturing methods.

An embodiment provides an electronic device comprising: at least one radio frequency identification tag, coated with a resin block; a cover forming, with the resin block, at least one notch; and at least one contacting element, located at the surface of the resin block inside of the notch.

According to an embodiment, the cover and the resin block together form two notches, each comprising at least one contacting element, the cover having, along a cross-section plane perpendicular to the length of the notches, a “T”-shaped cross-section.

According to an embodiment, the cover is made of silicon.

According to an embodiment, the resin block is made of at least one polymer material.

According to an embodiment, the cover is on top of and in contact with a passivation layer located on the surface of the resin block.

According to an embodiment, the chip has: a length in the range from 400 to 500 μm; a width in the range from 300 to 500 μm; and a thickness in the range from 50 to 100 μm.

According to an embodiment, the resin block enables to enlarge a surface area for attaching the cover.

According to an embodiment, the resin block enables to laterally offset connection pads of the radio frequency identification chip.

According to an embodiment, each notch is intended to receive a conductive wire, contacting the contacting element(s).

An embodiment provides a radio frequency identification tag comprising: at least one device such as described; and at least one conductive wire, engaged into the notch(es).

According to an embodiment, the conductive wire(s) form one or a plurality of antennas of the radio frequency identification chip.

An embodiment provides a textile yarn comprising at least one radio frequency identification tag such as described.

An embodiment provides a method of manufacturing a device such as described.

According to an embodiment, the method comprises the steps of:

positioning at least one radio frequency identification chip on a first support;
coating the radio frequency identification chip with a resin block;
transferring the chip onto a second support by means of the first support;
exposing active areas of the radio frequency identification chip;
depositing a dielectric layer at the surface of the resin block;
forming at least one connection pad and at least one contacting element; and
bonding a cover above the resin block, to form at least one notch at the level of the contacting element.

### BRIEF DESCRIPTION OF THE DRAWINGS

The foregoing and other features and advantages of the present invention will be discussed in detail in the following non-limiting description of specific embodiments and implementation modes in connection with the accompanying drawings, in which:

FIG. 1 is a simplified cross-section view of an example of assembly of an RFID tag comprising a cover;

FIG. 2 is a simplified view of an example of a machine enabling to assemble antenna wires on RFID tags;

FIG. 3 is a simplified perspective cross-section view of an embodiment of an RFID tag;

FIG. 4 is a simplified cross-section view of a step of an implementation mode of an RFID tag manufacturing method;

FIG. 5 is a simplified cross-section view of another step of the implementation mode of an RFID tag manufacturing method;

FIG. 6 is a simplified cross-section view of still another step of the implementation mode of an RFID tag manufacturing method;

FIG. 7 is a simplified cross-section view of still another step of the implementation mode of an RFID tag manufacturing method;

FIG. 8 is a simplified cross-section view of still another step of the implementation mode of an RFID tag manufacturing method;

FIG. 9 is a simplified cross-section view of still another step of the implementation mode of an RFID tag manufacturing method;

FIG. 10 is a simplified cross-section view of still another step of the implementation mode of an RFID tag manufacturing method;

FIG. 11 is a simplified cross-section view of still another step of the implementation mode of an RFID tag manufacturing method;

FIG. 12 is a simplified cross-section view of still another step of the implementation mode of an RFID tag manufacturing method;

FIG. 13 is a simplified cross-section view of still another step of the implementation mode of an RFID tag manufacturing method;

FIG. 14 is a partial simplified top view of another embodiment of an RFID tag;

FIG. 15 is a simplified view of an implementation mode of a method of integration of an RFID tag in a textile yarn;

FIG. 16A is a partial simplified perspective view of another embodiment of an RFID tag; and

FIG. 16B is a partial simplified top view of the RFID tag of FIG. 16A.

### DETAILED DESCRIPTION OF THE PRESENT EMBODIMENTS

Like features have been designated by like references in the various figures. In particular, the structural and/or functional elements common to the different embodiments and implementation modes may be designated with the same reference numerals and may have identical structural, dimensional, and material properties.

For clarity, only those steps and elements which are useful to the understanding of the described embodiments and implementation modes have been shown and will be detailed. In particular, the radio frequency identification chips, or RFID chips, and the RFID chip manufacturing methods are not described, the invention being compatible with usual RFID chips and with usual RFID chip manufacturing methods.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, when reference is made to terms qualifying absolute positions, such as terms “front”, “rear”, “top”, “bottom”, “left”, “right”, etc., or relative positions, such as terms “above”, “under”, “upper”, “lower”, etc., or to terms qualifying directions, such as terms “horizontal”, “vertical”, etc., unless specified otherwise, it is referred to the orientation of the drawings, it being understood that, in practice, the devices may be oriented differently.

Unless specified otherwise, the expressions “around”, “approximately”, “substantially” and “in the order of” signify within 10%, and preferably within 5%.

FIG. 1 is a simplified cross-section view of an example of assembly of a radio frequency identification tag 100, or RFID tag, comprising a cover.

In this example, RFID tag 100 comprises a radio frequency identification chip 102 or RFID chip. RFID chip 102 is symbolized in FIG. 1 by a rectangle. On a surface 104 of chip 102 (the upper surface of chip 102 in the orientation of FIG. 1) are exposed two connection pads 106a and 106b of chip 102. The connection pads 106a and 106b of chip 102 are, for example, coupled or connected to a radio frequency communication circuit of chip 102, not shown in FIG. 1.

Connection pads 106a and 106b are for example respectively located close to two opposite lateral surfaces of RFID chip 102, the left-hand and right-hand lateral surfaces of chip 102, in the orientation of FIG. 1. As illustrated in FIG. 1, an area 108 of the surface 104 of chip 102 separates connection pads 106a and 106b.

In the example of FIG. 1, RFID tag 100 further comprises a cover 110 rigidly attached to chip 102. Cover 110 for example has a “T” shaped cross-section. As illustrated in FIG. 1, the lower surface of the vertical portion of the “T” formed by cover 110 is attached to at least a portion of area 108 of surface 104 of chip 102. Cover 110 is centered with respect to surface 104 of chip 102. The horizontal portion of the “T” formed by cover 110 is located opposite connection pads 106a and 106b of chip 102, and has lateral dimensions similar to those of chip 102.

RFID chip 102 and cover 110 together form a structure 112. As illustrated in FIG. 1, structure 112 has an “I”-shaped cross-section having its lower horizontal portion formed by chip 102 and having its vertical portion and its upper horizontal portion formed by cover 110. In this example, two notches 114a and 114b or grooves, located on either side of the vertical portion of the “I” formed by structure 112, vertically separate connection pads 106a and 106b from cover 110.

In the example of FIG. 1, RFID tag 100 further comprises two antenna wires 116a and 116b. Antenna wires 116a and 116b respectively insert into notches 114a and 114b of structure 112. Cover 110 maintains wires 116a and 116b in contact with the connection pads 106a and 106b of RFID chip 102.

Wires 116a and 116b are for example substantially parallel to each other and substantially parallel to surface 104 of chip 102. In the example of FIG. 1, each antenna wire 116a, 116b has a circular cross-section. Wires 116a and 116b are welded to pads 106a and 106b. Wires 116a and 116b extend along a direction perpendicular to the cross-section plane of FIG. 1, over a length exceeding the dimensions of chip 102 and of cover 110. Antenna wires 116a, 116b extend, for example, over a length of a few tens of centimeters.

In the following description, the height, noted H, of notches 114a and 114b designates the distance between pads 106a, respectively 106b, and cover 110. Further, the length of notches 114a and 114b designates the dimension of notches 114a and 114b measured parallel to the axis of wires 116a and 116b, in other words the length of notches 114a and 114b perpendicular to the cross-section plane of FIG. 1.

The notches 114a and 114b of structure 112, seen in cross-section in FIG. 1, substantially have a same depth, noted P. As illustrated in FIG. 1, the depth P of notches 114a and 114b is measured along a direction perpendicular to the height and length of notches 114a and 114b.

It is generally ascertained that the depth P of the notches 114a and 114b of structure 112 is sufficiently large to enable to totally engage wires 116a and 116b into them. In particular, as illustrated in the cross-section view of FIG. 1, depth P is greater than the diameter of wires 116a and 116b. This particularly enables to center wires 116a and 116b with respect to pads 106a and 106b of chip 102, for example, to obtain a good electric contact. This also enables to obtain a satisfactory mechanical hold, particularly to avoid for wires 116a and 116b not to come out of notches 114a and 114b.

Note L the width of the contact surface, noted S, between cover 110 and chip 102. In the example of FIG. 1, width L corresponds to the width of the lower surface of the vertical portion of the “T” formed by cover 110, in contact with all or part of area 108 of the surface 104 of chip 102. As illustrated in FIG. 1, the width L of surface S depends on the depth P of notches 114a, 114b and on a lateral dimension, noted D, of chip 102.

For simplification, it is considered that chip 102 has, in top view, a square shape of side length D. In this case, contact surface S between cover 110 and area 108 of surface 104 of chip 102 has a rectangular shape with a length D, a width L, and an area equal to L×D.

A decrease in the size of chip 102, for example, a decrease in dimension D of chip 102 causes, for an identical depth P, a decrease in the contact surface area S between chip 102 and cap 110. Such a decrease in surface area S tends to fragilize the attaching of cover 110 to chip 102, and thus the structure 112 of RFID tag 100.

To compensate for the decrease of dimension D and avoid decreasing the area of surface S, it could be devised to decrease the depth P of notches 114a and 114b, but this would particularly result in decreasing the surface area of connection pads 106a and 106b. It would then be risked to obtain a poor electric contact between wires 116a, 116b, and pads 106a and 106b. Further, a decrease in depth P could degrade the mechanical resistance of antenna wires 116a and 116b. In particular, wires 116 and 116b located too close to the periphery of structure 112 would be likely to be incidentally extracted out of their respective notches 114a, 114b during the use of RFID tag 100.

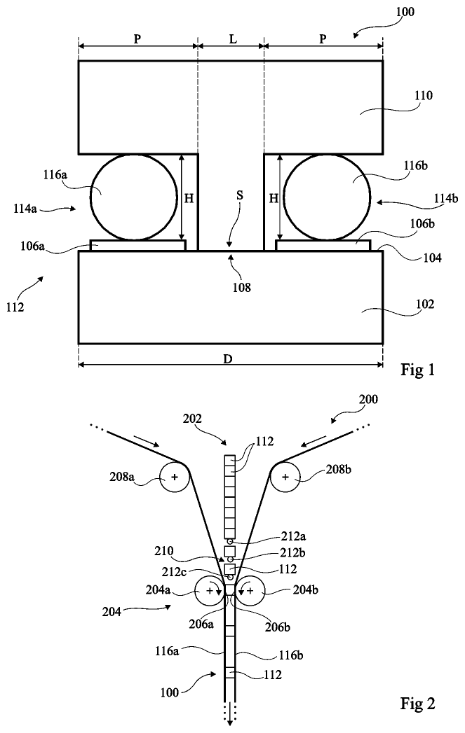

RFID chip 102 and cover 110 are for example assembled by implementing a technology known under trade name “E-Thread”, briefly disclosed hereafter in relation with FIG. 2.

FIG. 2 is a simplified view of an example of a machine 200 enabling to assemble antenna wires on RFID tags in the context of the E-Thread technology. Machine 200 for example enables to insert wires 116a and 116b into grooves 114a and 114b of structure 112. Such an example is described in patent application No 2390194, which is herein incorporated by reference to the maximum extent authorized by law.

In the example of FIG. 2, a series of structures 112, each comprising chip 102 and cover 110 (FIG. 1), are put to wait in a feed area 202 of assembly machine 200. In practice, feed area 202 may comprise a groove adapted to the lateral dimensions of structures 112, for example, a groove having a width greater than the lateral dimension D of chip 102. Structures 112 are stored in feed area 202 so that their notches 114a, 114b are aligned with respect to one another.

A pinching device 204, for example comprising two cylindrical counter rotating rollers 204a, 204b, is placed at the bottom of area 202, in the orientation of FIG. 2. Pinching device 204 is for example a passive device having its rollers 204a and 204b separated from each other by a substantially constant distance. The rotation axes of rollers 204a and 204b are substantially perpendicular to wires 116a and 116b. As illustrated in FIG. 2, two opposite surfaces 206a and 206b of rollers 204a and 204b are separated by a distance approximately equal to the lateral dimension D (FIG. 1) of structure 112.

Wires 116a and 116b are for example respectively unwound from reels, not shown, along auxiliary rollers 208a and 208b. Wires 116a and 116b are then placed into contact with the opposite surfaces 206a and 206b of rollers 204a and 204b. At the output of machine 200, wires 116a and 116b are maintained parallel to one another, at a distance shorter than the lateral dimension D of the chip 102 of each structure 112. Auxiliary rollers 208a and 208b enable to guide wires 116a and 116b towards pinching device 204 to avoid possible interferences with the structures 112 present in feed area 202.

A device 210, arranged between feed area 202 and pinching device 204, enables to regulate the passage of structures 112 between rollers 204a and 204b. In the example of FIG. 2, device 210 comprises three fingers 212a, 212b, and 212c particularly enabling to separate structures 112 and to have them pass one after the other through pinching device 204.

As a structure 112 approaches rollers 204a and 204b, wires 116a and 116b progressively engage into notches 114a and 114b. Device 210 then pushes structure 112 between opposite surfaces 206a and 206b. This results in forcing in the introduction of wires 116a and 116b into notches 114a and 114b, over the entire length of notches 114a and 114b, as structure 112 passes between rollers 204a and 204b. Subsequent operations may be provided, for example, to weld wires 116a, 116b to the corresponding connection pads 106a, 106b.

At the output of machine 200, a “string” of structures 112 assembled with antenna wires 116a and 116b is obtained, which can be subsequently separated to obtain individual RFID tags 100.

One of rollers 204a, 204b is for example assembled on a slide rail, not shown, and taken closer to the other roller by a return spring, not shown. The tolerance of machine 200 is thus improved by avoiding, for example, deteriorating structures 112 having a lateral dimension greater than dimension D.

A decrease in the size of chip 102 tends to complicate the use of assembly machine 200. In particular, the smaller chip 102, the narrower the transfer surface area 108 of cover 110. Thereby, cover 110 is more likely to separate from chip 102 under the effect, for example, of mechanical stress applied by rollers 204a, 204b onto structure 112 during the insertion of wires 116a and 116b into notches 114a and 114b. The mechanical resistance of tag 100 is thus also degraded during its use.

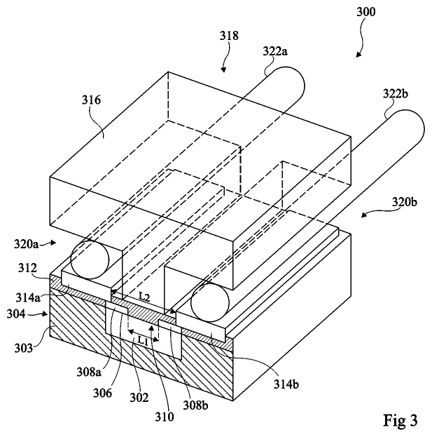

FIG. 3 is a simplified cross-section perspective view of an embodiment of an RFID tag 300.

RFID tag 300 comprises an RFID chip 302 similar to RFID chip 102 such as described in relation with FIG. 1. According to an embodiment, RFID chip 302 is coated with a portion 303 of a resin block 304. Portion 303 of resin block 304 is made of at least one polymer material. RFID chip 302 is preferably coated with portion 303 of resin block 304 so that its lateral and lower surfaces are totally surrounded with portion 303 of resin block 304. As illustrated in FIG. 3, the upper surface of portion 303 of resin block 304 is flush with a surface of chip 302 (the upper surface of chip 302, in the orientation of FIG. 3).

According to an embodiment, the chip 302 of RFID tag 300 has:

a length in the range from 300 to 500 μm, for example, equal to 464 μm;
a width in the range from 300 to 500 μm, for example, equal to 442 μm; and
a thickness in the range from 200 to 300 μm.

According to a preferred embodiment, the chip 302 of RFID chip 300 is thinned to obtain a chip 302 having a thickness in the range from 50 to 100 μm, for example, equal to 70 μm.

RFID chip 302 comprises, on its surface 306, two connection pads 308a and 308b. Connection pads 308a and 308b of chip 302 may be coupled or connected to a radio frequency communication circuit of chip 302, not shown in FIG. 3. The connection pads 308a and 308b of chip 302 are respectively located close to two opposite lateral surfaces of RFID chip 302 (the left-hand and right-hand lateral surfaces of chip 302, in the orientation of FIG. 3).

Resin block 304 further comprises a passivation layer 312. According to an embodiment, passivation layer 312 is located on top of and in contact with the upper surface of portion 303 of resin block 304. Two contacting elements 314a and 314b are flush with passivation layer 312. Contacting elements 314a and 314b are respectively connected to the connection pads 308a and 308b of chip 302.

According to an embodiment, contacting elements 314a and 314b are respectively located close to two opposite lateral surfaces of resin block 304 (the left-hand and right-hand lateral surfaces of resin block 304, in the orientation of FIG. 3). Contacting elements 314a and 314b enable to laterally offset, at the surface of resin block 304, the connection pads 308a and 308b of chip 302.

As illustrated in FIG. 3, contacting elements 314a and 314b partially overlap the connection pads 308a and 308b of chip 302. In particular, in the orientation of FIG. 3, contacting element 314a is on top of and in contact with a portion of the upper surface of connection pad 308a and laterally extends towards the lateral left-hand surface of resin block 304. Similarly, still in the orientation of FIG. 3, contacting element 314b is on top of and in contact with a portion of the upper surface of connection pad 308b and laterally extends towards the right-hand lateral surface of resin block 304.

As a variant, contacting elements 314a and 314b do not overlap connection pads 308a and 308b of chip 302. Should the case arise, each contacting element 314a, 314b is connected to the associated connection pad 308a, 308b by at least one conductive track (not shown in FIG. 3).

In the shown example, chip 302 is surrounded or coated, on all its surfaces, with resin block 304 and passivation layer 312, except for areas of contact with contacting elements 314a and 314b. More particularly, in the orientation of FIG. 3:

the resin of block 304 integrally coats the lower surface and the lateral surfaces of chip 302; and
passivation layer 312 integrally coats the upper surface of chip 302, except for areas of the upper surfaces of the connection pads 308a and 308b of chip 302 coated with contacting elements 314a and 314b.

In the example of FIG. 3, RFID tag 300 further comprises a cover 316. Cover 316 forms one piece with the resin block 304 coating RFID chip 302. More particularly, as illustrated in FIG. 3, cover 316 forms one piece with the passivation layer 312 of resin block 304. According to an embodiment, cover 316 has a “T”-shaped cross-section. Cover 316 is preferably made of silicon.

As an example, cover 316 is attached to the passivation layer 312 of resin block 304 by an adhesive material, for example, glue. Such an adhesive material is for example selected according to the material of cover 316. Further, passivation layer 312 is for example made of a material selected according to the adhesive material. This particularly enables to favor the adhesion of the glue to passivation layer 312. The mechanical robustness of the bonding of cover 316 to resin block 304 is thus improved.

In a case where chip 302 has lateral dimensions smaller than those of the cover, for example, an upper surface area 306 from two to ten times smaller than the upper surface area of resin block 304, the effects of the thermal expansion of block 304 are preponderating over those of chip 302. In this case, the resin of block 304 is selected so that it for example has a thermal expansion coefficient close to that of the material of cover 316, for example substantially equal to that of the material of cover 316.

As compared with a case where cover 316 would be directly attached to chip 302, the fact of attaching cover 316 to resin block 304 thus enables to widen the selection of possible materials for cover 316 and/or block 304. The forming of RFID tag 300 is thus eased while guaranteeing an optimal mechanical robustness.

As illustrated in FIG. 3, the lower surface of the vertical portion of the “T” formed by cover 316 is attached between contacting elements 314a and 314b. Cover 316 is centered with respect to resin block 304. The horizontal portion of the “T” formed by cover 316 is located opposite contacting elements 314a and 314b, and has lateral dimensions similar to those of resin block 304.

Resin block 304 and cover 316 together form a structure 318. As illustrated in FIG. 3, structure 318 has an “I”-shaped cross-section, having its lower horizontal portion formed by resin block 304 and having its vertical portion and its upper horizontal portion formed by cover 316. In this example, two notches 320a and 320b or grooves, located on either side of the vertical portion of the “I” formed by structure 318, vertically separate contacting elements 314a, 314b from cover 316.

According to an embodiment, RFID tag 300 further comprises two antenna wires 322a and 322b. Antenna wires 322a and 322b respectively insert into notches 320a and 320b of structure 318. Cover 316 maintains wires 322a and 322b in contact with the contacting elements 314a and 314b of RFID chip 302.

Wires 322a and 322b are preferably substantially parallel to each other and substantially parallel to the upper surface of resin block 304. In the example of FIG. 3, each antenna wire 322a, 322b has a circular cross-section. Wires 322a and 322b extend along a direction perpendicular to the cross-section plane of FIG. 3, over a length exceeding the dimensions of resin block 304 and of cover 316. For clarity, only a portion of each conductive wire 322a, 322b has been shown in FIG. 3, it being understood that, in practice, each wire 322a, 322b may have a length greater that what is illustrated in FIG. 3.

As illustrated in FIG. 3, the connection pads 308a and 308b of chip 302 are separated by a distance L1, and contacting elements 314a and 314b are separated by a distance L2. According to a preferred embodiment, it is made sure that distance L2 is greater than distance L1.

As a variant, the chip 302 of RFID tag 300 comprises a single connection pad, for example, connection pad 308b. Contacting element 314a, notch 320, and antenna wire 322a may be omitted. The shape of cover 316 may then be modified to maximize the surface area of contact with passivation layer 312 so that structure 318 has a “C” shape.

An advantage of RFID tag 300 is the fact that the presence of resin block 304 enables to attach cover 316 above RFID chip 302, to benefit from a surface area greater than a portion 310 of upper surface area 306 of chip 302 located between pads 308a and 308b. This particularly enables to improve the mechanical resistance of structure 318 on insertion of wires 322a and 322b into notches 320a and 320b as well as during the use of RFID tag 300.

Another advantage of RFID tag 300 is that contacting elements 314a and 314b each have an upper surface area larger than the upper surface area of the connection pads 308a and 308b of chip 302. This particularly enables to improve the mechanical contact and the mechanical resistance between each antenna wire 322a and 322b and the contacting element 314a, 314b which is associated therewith.

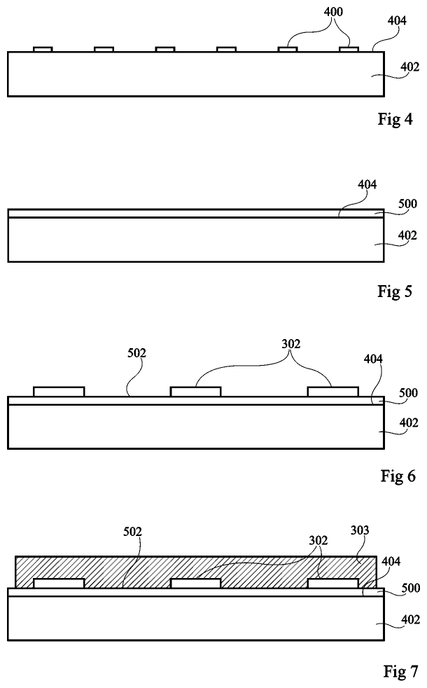

FIGS. 4 to 13 hereafter illustrate successive steps of a same implementation mode of a method of forming RFID tags, for example, RFID tags 300 (FIG. 3).

FIG. 4 is a simplified cross-section view of a step of the implementation mode of the RFID tag manufacturing method.

During this step, alignment marks 400 are formed on a support 402. Alignment marks 400 are particularly intended to enable to accurately place chips on support 402 during a subsequent step. Alignment marks 400 are for example pads formed at surface 404 of support 402 (the upper surface of support 402, in the orientation of FIG. 4) or optical marks. According to an embodiment, support 402 is a silicon wafer or a piece of a silicon wafer. As variant, support 402 is made of glass. More generally, support 402 is made of a material compatible with a use in a white room and enabling to ensure a mechanical support function. Support 402 preferably has a thickness of approximately 500 μm.

For clarity, alignment marks 400 are not shown in FIGS. 5 to 13 hereafter.

FIG. 5 is a simplified cross-section view of another step of the implementation mode of the RFID tag manufacturing method, carried out from the structure such as described in relation with FIG. 4.

During this step, a film 500 is placed at surface 404 of support 402. According to an implementation mode, film 500 is a two-faced adhesive film. Film 500 is preferably a two-faced adhesive film capable of being separated under the effect of heat, for example, a film known under trade name “REVALPHA” of company Nitto.

According to an implementation mode, film 500 is glued to the entire upper surface 404 of support 402. According to another implementation mode, film 500 is glued to a portion of upper surface 404 of support 402, in particular at locations of surface 404 intended to receive chips in a subsequent step.

FIG. 6 is a simplified cross-section view of still another step of the implementation mode of the RFID tag manufacturing method, carried out from the structure such as described in FIG. 5.

During this step, electronic dies, for example, RFID chips 302 (FIG. 3), are arranged at surface 502 of adhesive film 500. According to an implementation mode, chips 502 are positioned at surface 502 of film 500 due to alignment marks 400 (FIG. 4), not shown in FIG. 6 since they are covered with adhesive film 500. For simplification, only three chips 302 have been shown in FIG. 6, given that, in practice, surface 502 of film 500 may receive any number of chips 302.

According to an embodiment, the active area of chips 302 is placed in contact with surface 502 of film 500. Chips 302 have a thickness for example equal to approximately 70 μm, preferably equal to 70 μm. According to an embodiment, chips 302 are submitted, prior to their positioning at surface 502 of film 500, steps (not shown) of dicing before grinding and of plasma stress release.

FIG. 7 is a simplified cross-section view of still another step of the implementation mode of the RFID tag manufacturing method, carried out from the structure such as described in FIG. 6.

During this step, the chips 302 located at the surface 502 of adhesive 500 are encapsulated. According to an implementation mode, chips 302 are encapsulated by compression molding. An encapsulation block, for example, the portion 303 of resin block 304 (FIG. 3), is thus formed at surface 502 of adhesive film 500. Encapsulation block 303 integrally covers chips 302. Encapsulation block 303 has a thickness in the range from 200 to 400 μm, for example, equal to 300 μm.

According to a preferred implementation mode, encapsulation block 303 is formed by compression molding of a liquid polymer resin deposited at surface 502 of adhesive film 500 to integrally cover chip 302. Encapsulation block 303, thus molded around 302, is then submitted to post-molding curing step.

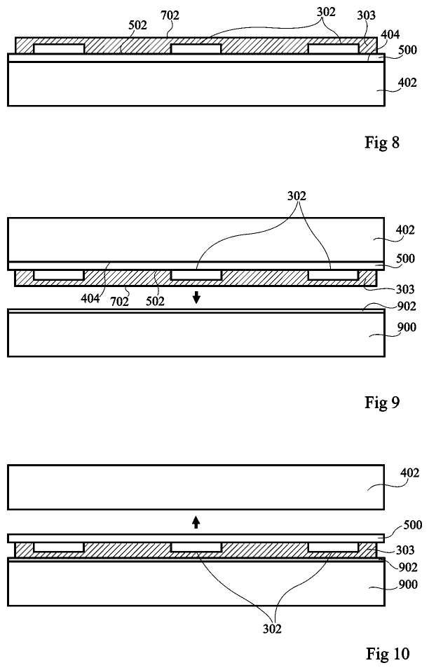

FIG. 8 is a simplified cross-section view of still another step of the implementation mode of the RFID tag manufacturing method, carried out from the structure such as described in FIG. 7.

During this step, encapsulation block 303 is thinned. According to an embodiment, the thinning of encapsulation block 303 is performed by epoxy grinding. In the example where chips 302 have a thickness equal to 70 μm and where encapsulation block 303 initially has a thickness equal to 300 μm, encapsulation block 303 is thinned to obtain a thickness of approximately 100 μm.

As illustrated in FIG. 8, thinned encapsulation block 303 still integrally covers chips 302. More particularly, in the example where the chip height is equal to 70 μm and where encapsulation block 303 has been thinned by 200 μm, a 30-μm thickness still separates each chip 302 from surface 702 of encapsulation block 303.

FIG. 9 is a simplified cross-section view of still another step of the implementation mode of the RFID tag manufacturing method, carried out from the structure such as described in FIG. 8.

During this step, the structure obtained at the end of the step described in relation with FIG. 8 is flipped. More particularly, the structure comprising support 402, adhesive 500, chips 302, and encapsulation block 303 is flipped so that surface 702 of encapsulation block 303 faces downwards as illustrated in FIG. 9.

During this step, surface 702 of encapsulation block 303 is then placed into contact with another support 900 having an upper surface which has been previously covered with a bonding layer 902, preferably temporary. Support 900 is for example a silicon wafer or a piece of a silicon wafer. As variant, support 900 is made of glass. More generally, support 900 may be similar to support 402. Support 900 may in particular have dimensions approximately equal to those of support 402 and a composition similar to that of support 402. Support 900 is preferably aligned with respect to support 402.

According to an implementation mode, layer 902 enables to create, between support 900 and encapsulation 303, a stronger bond than between adhesive film 500 and support 402 and than between adhesive film 500 and encapsulation block 303. Layer 902 is for example a glue layer. Layer 902 is then preferably a temporary glue layer having a controlled bonding to be releasable by a thermal or chemical treatment. As a variant, layer 902 is preferably a two-faced adhesive film capable of being separated under the effect of heat, for example, a film known under trade name “REVALPHA” of company Nitto. Layer 902 may preferably have a release temperature different from that of film 500.

FIG. 10 is a simplified cross-section view of still another step of the implementation mode of the RFID tag manufacturing method, carried out from the structure such as described in FIG. 9.

During this step, support 402 is separated or detached from film 500. After the removal of support 402, a structure formed of the following elements is obtained (from bottom to top, in the orientation of FIG. 10):

support 900;
bonding layer 902;
encapsulation block 303 integrally covering chips 302; and
adhesive film 500.

In other words, the steps described in relation with FIGS. 9 and 10 enable to transfer chips 302 from support 402 to support 900.

FIG. 11 is a simplified cross-section view of still another step of the implementation mode of the RFID tag manufacturing method, carried out from the structure such as described in FIG. 10.

During this step, the adhesive film 500 covering a surface 704 of encapsulation block 303 (the upper surface of encapsulation block 303, in the orientation of FIG. 11) is separated. The surface 704 of encapsulation block 303, as well as the active areas of chips 302, are thus exposed.

According to an implementation mode, the removal of adhesive film 500 is performed by heating. During this step, possible excess glue present on surface 704 of encapsulation block 303 and/or at the surface of chips 302 is also removed.

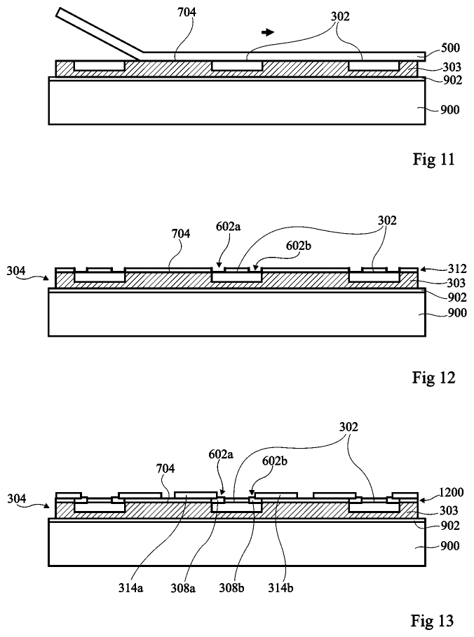

FIG. 12 is a simplified cross-section view of still another step of the implementation mode of the RFID tag manufacturing method, carried out from the structure such as described in FIG. 11.

During this step, a dielectric layer made of polymer material at surface 704 of encapsulation block 303 is formed. According to an implementation mode, the dielectric layer is passivation layer 312 (FIG. 3). Layer 312 is a discontinuous layer covering surface 704 of encapsulation block 303 and a portion of the upper surface of each chip 302. In particular, areas 602a and 602b of connection of chips 302 are not covered with layer 312. Layer 312 and block 303 together form the resin block 304 such as described in relation with FIG. 3.

FIG. 13 is a simplified cross-section view of still another step of the implementation mode of the RFID tag manufacturing method, carried out from the structure such as described in FIG. 12.

During this step, one or a plurality of redistribution layers (RDL) are formed on the side of surface 704 of encapsulation block 303. According to an implementation mode, connection pads 308a, 308b are thus formed in line with the connection areas 602a, 602b of each chip 302. The associated contacting elements 314a, 314b are further formed, each contacting element 314a, 314b partially overlapping the corresponding connection pad 308a, 308b and extending at the surface of dielectric layer 312.

According to an implementation mode, the redistribution layer(s) are formed by physical vapor deposition (PVD).

Subsequent steps (not shown) of dicing of the structure such as described in relation with FIG. 13 and of bonding of covers 316 to obtain structures 318, and then of insertion of antenna wires 322a, 322b to obtain RFID tags 300 (FIG. 3), are then executed.

The practical implementation of the steps of the method described hereabove in relation with FIGS. 4 to 13 may be based on fan-out wafer level packaging or “FOWLP” methods, where a wafer is diced to separate chips, the chips then being repositioned on a support by forming a sufficient space between them to form contacting elements.

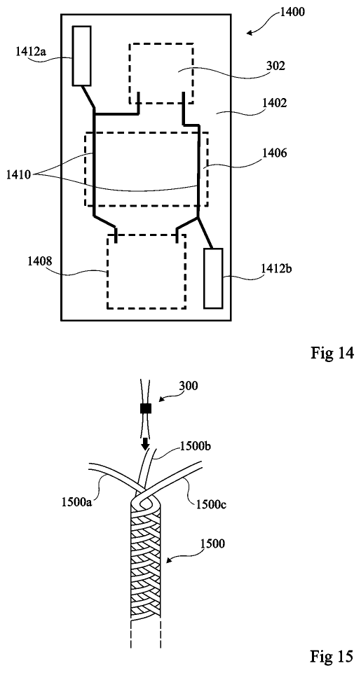

FIG. 14 is a partial simplified top view of another embodiment of an RFID tag 1400 in top view. For clarity, the cover and the antenna wires of RFID tag 1400, which are respectively similar to the cover 316 and to the wires 322a, 322b of tag 300 (FIG. 3) have not been shown in FIG. 14.

According to an embodiment, RFID tag 1400 comprises a resin block 1402 coating components 1406 and 1408 and a radio frequency identification chip, for example RFID chip 302 (FIG. 3). According to an embodiment:

component 1406 is an energy storage element, for example, a capacitive component;
component 1408 is a sensor, for example, a temperature sensor, a hygrometry sensor, a pressure sensor, etc.; and
RFID chip 302 integrates functionalities enabling it to record and/or to process data acquired by sensor 1408.

As illustrated in FIG. 14, conductive tracks 1410 at the surface of resin block 1402 enable to connect components 1406, 1408 and chip 302 together and to contacting elements 1412a and 1412b. According to an embodiment, resin block 1402 receives a cover similar to cover 316 (FIG. 3) forming, with block 1402, two notches (not shown) located vertically in line with contacting elements 1412a and 1412b and along RFID tag 1400. In this case, the contacting elements 1412a and 1412b of RFID tag 1400 are similar to the contacting elements 314a and 314b of RFID tag 300 (FIG. 3), with the difference that, in FIG. 4, contacting elements 1412a, 1412b are offset with respect to each other.

In the embodiment illustrated on FIG. 14, components 1406, 1408 and chip 302 are all connected together and are all connected to contacting elements 1412a and 1412b via conductive tracks 1410. This for example enables energy storage component 1406 to sample energy from a field captured by antenna wires (not shown) connected to contacting elements 1412a and 1412b, to store this energy, and to redistribute it to component 1408 and to chip 302.

As a variant, only certain elements, among components 1406 and 1408 and chip 302, are connected together and/or are connected to contacting elements 1412a and 1412b.

According to an embodiment, conductive tracks 1410 are antenna elements.

An advantage of RFID tag 1400 is to enable to connect a plurality of elements, among components 1406 and 1408 and chip 302, together and/or to contacting elements 1414a and 1414b. In other words, advantage is taken of the presence of resin block 1402 to form interconnections between components 1406, 1408, chip 302, and contacting elements 1412a and 1412b. Such interconnections are preferably formed by photolithographic etching, which enables to achieve a high accuracy level.

FIG. 15 is a simplified view of an implementation mode of a method of integrating an RFID tag, for example, RFID tag 300, in a textile yarn 1500.

According to this implementation mode, RFID tag 300 is integrated to yarn 1500 during a step of braiding wire 1500 from three strands 1500a, 1500b, and 1500c. According to an implementation mode, RFID tag 300 has decreased dimensions, so that the integration of tag 300 in wire 1500 causes an increase, almost invisible with the naked eye, of the diameter of yarn 1500. This thus enables to hide tag 300 in textile yarn 1500.

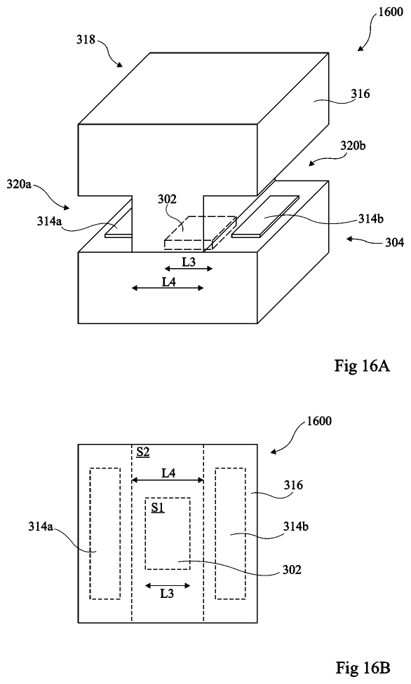

FIGS. 16A and 16B are partial simplified respective perspective views of another embodiment of an RFID tag 1600.

The RFID tag 1600 of FIGS. 16A and 16B comprises elements common with the RFID tag 300 of FIG. 3. The common elements will not be detailed again hereafter. The RFID tag 1600 of FIGS. 16A and 16B differs from the RFID tag 300 of FIG. 3 mainly in that the RFID chip 302 of tag 1600 has a lateral dimension L3 smaller than a lateral dimension L4 of the lower portion of the cover. In the shown example, chip 302 has an upper surface having surface area S1 smaller than a surface area S2 of contact of cover 316 with resin block 304.

In the case of RFID tag 1600, pads 106a and 106b of connection of chip 102 (not shown in FIGS. 16A and 16B) are for example connected to contacting elements 314a and 314b by conductive tracks (not shown) or by other contacting elements (not shown). It will be within the abilities of those skilled in the art to provide adequate connection means between each pad 106a, 106b and the associated contacting element 314a, 314b to form RFID tag 1600.

The embodiment of RFID tag 1600 discussed hereabove in relation with FIGS. 16a and 16b advantageously enables to form a structure 318 similar to that of RFID tag 300 in the case where chip 302 for example has an upper surface area S1 which is too small with respect to the contact surface area S2 enabling to guarantee the attachment of cover 316. In particular, RFID tag 1600 has a mechanical robustness adapted to the previously-mentioned applications whatever the dimensions of chip 302, particularly its surface area S1, with respect to the dimensions of cover 316.

Various embodiments, implementation modes, and variants have been described. Those skilled in the art will understand that certain features of these various embodiments, implementation modes, and variants may be combined, and other variants will occur to those skilled in the art. In particular, the adaptation of the implementation mode of the RFID tag forming method described in relation with FIGS. 4 to 13 to form RFID tags 300 and 1400 is within the abilities of those skilled in the art based on the above indications.

Finally, the practical implementation of the described embodiments, implementation modes, and variations is within the abilities of those skilled in the art based on the functional indications given hereabove. In particular, the forming of the redistribution layers enabling to obtain the contacting elements 314a and 314b of tag 300 as well as the contacting elements 1412a and 1412b and the conductive tracks 1410 of tag 1400 are within the abilities of those skilled in the art based on the above indications.

1. An electronic device comprising:
at least one radio frequency identification chip, coated with a resin block;
a cover on top of and in contact with a passivation layer located at the surface of the resin block, the cover forming, with the resin block, at least one notch; and
at least one contacting element, located at the surface of the resin block inside of the notch,
each notch being intended to receive a conductive wire, contacting the contacting element(s).

2. The device according to claim 1, wherein the chip is coated, on all of its surfaces, with the resin block and the passivation layer, except for areas of contact with the contacting elements.

3. The device according to claim 1, wherein the cover and the resin block together form two notches, each comprising at least one contacting element, the cover having, along a cross-section plane perpendicular to the length of the notches, a “T”-shaped cross-section.

4. The device according to claim 1, wherein the cover is made of silicon.

5. The device according to claim 1, wherein the resin block is made of at least one polymer material.

6. The device according to claim 1, wherein the chip has:
a length in the range from 300 to 500 μm;
a width in the range from 300 to 500 μm; and
a thickness in the range from 50 to 100 μm.

7. The device according to claim 1, wherein the resin block enables to enlarge a surface area for attaching the cover.

8. The device according to claim 1, wherein the resin block enables to laterally offset connection pads of the radio frequency identification chip.

9. The device according to claim 1, wherein the chip has an upper surface with a surface area smaller than a surface area of contact of the cover with the resin block.

10. A radio frequency identification tag comprising:
at least one device according to claim 1; and
at least one conductive wire engaged into the notch(es).

11. The tag according to claim 10, wherein the conductive wire(s) form one or a plurality of antennas of the radio frequency identification chip.

12. A textile yarn comprising at least one radio frequency identification tag according to claim 11.

13. A method of manufacturing the device according to claim 1.

14. The method of claim 13, comprising the steps of:
positioning at least one radio frequency identification chip on a first support;
coating the radio frequency identification chip with a resin block;
transferring the chip onto a second support by means of the first support;
exposing active areas of the radio frequency identification chip;
depositing a dielectric layer at the surface of the resin block;
forming at least one connection pad and at least one contacting element; and
bonding a cover above the resin block, to form at least one notch at the level of the contacting element.
